(19) United States
(12) Patent Application Publication
(10) Pub. No.: US 2023/0353557 A1
(43) Pub. Date: Nov. 2, 2023

(54) AUTHENTICATION ORCHESTRATION ACROSS REMOTE APPLIANCES

(71) Applicant: VMware, Inc., Palo Alto, CA (US)

(72) Inventors: Stanimir Lukanov, Sofia (BG); Kamen Mazdrashki, Sofia (BG); Georgi Lyubomirov Dimitrov, Sofia (BG); Dimo Raychev, Sofia (BG); Georgi Lekov, Sofia (BG)

(21) Appl. No.: 17/732,311

(22) Filed: Apr. 28, 2022

(51) Int. Cl. H04L 9/40

(52) U.S. Cl. CPC H04L 63/083; H04L 63/0823

(57) ABSTRACT

Bootstrapping a new remote appliance based on a request received at a main appliance based on established trust between the two appliances can be implemented as computer-implemented methods, media, and systems. A request is received at an authentication orchestrator at the main appliance to perform an operation requested by a user for execution on a remote appliance. The authentication orchestrator at the main appliance obtains an authentication token issued by an identity provider at the main appliance for the user associated with the request. The authentication orchestrator requests to exchange the authentication token issued by the identity provider at the main appliance for a new authentication token that is issued by an identity provider at the remote appliance. The authentication orchestrator at the main appliance initiates an authentication of the user at an appliance manager at the remote appliance based on providing the new authentication token.

### BACKGROUND

This specification relates to authorization of user requests to execute operations on remote service environments from a main service environment.

Software applications can provide services and access to resources. In some cases, resources may be restricted based on authorization right. For example, different access rights may be provided to different users and/or user roles for different operations. Execution of services at different environments (e.g., servers, platforms, applications) may require authentication of user's identity based on a credentials verification.

### SUMMARY

This specification describes technologies relating to an authentication orchestration across multiple appliances running on remote landscapes.

In particular, this specification describes an automatic way to orchestrate a multi-token exchange on behalf of a user logged on to a first appliance and who invokes one or more services in a remote trust domain at a second appliance. The multi-token exchange can be performed based on a one-way trust established between a domain that the user belongs to (at the first appliance) and the remote trust domain (at the second appliance).

Particular embodiments of the subject matter described in this specification can be implemented so as to realize one or more of the following advantages.

An automatic orchestration of the exchange of tokens to authenticate a user at a remote appliance based on established one-way trust between an identity layer at the remote appliance to the identity layer at the first appliance can be supported in an efficient yet simple manner. Using techniques described in this specification, based on established trust between appliances, the system can perform authentication of users at a remote appliance faster are more reliably. Further, the separation of resources between multiple appliances and independent execution of a service at a remote appliance that was requested from a first main appliance can support high service availability. Even if the main appliance experiences a period of limited service availability (e.g., downtime, restart, update or upgrade, among other examples), the system can execute a service requested at the main appliance at a remote separate appliance that can be autonomous in providing requested services.

The details of one or more implementations of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a schematic diagram illustrating an example computing environment that establishes trust between identity providers at a first appliance and a second appliance.

FIG. 2A is a flowchart of an example process for bootstrapping a second remote appliance from a first main appliance as an autonomous appliance that runs independently

FIG. 2B is a flowchart of an example process for authenticating a user at a second appliance based on user's authentication at a first appliance.

FIG. 3 is a schematic diagram illustrating an example computing environment where a second appliance, based on a request received at a first appliance, is bootstrapped as an autonomous appliance that includes an identity layer that trusts the identity layer of the first appliance.

Like reference numbers and designations in the various drawings indicate like elements.

### DETAILED DESCRIPTION

This specification describes techniques for bootstrapping a new appliance based on a request received at a main appliance. Trust is established between the two appliances so that an authenticated user at the main appliance can be authenticated at the new appliance, e.g., a remote second appliance, to consume services provided at the new appliance that require authentication.

In some implementations, server management software can support management of virtual workloads at computing centers and/or servers. An administrator can configure a server system to be accessible by multiple users based on provided credentials including sensitive information and/or based on token-based authentication. Token-based authentication can improve server and/or system security and may not require that a user enter their credentials every time that the user requests services from the underlying server and/or system. Token-based authentication is an identity verification mechanism that can provide security while maintaining usability for an end user interacting with the server and/or system.

To maintain high availability and timely responsiveness, a server can be configured to respond to a user action by spawning a new ad-hoc environment (or system or service) dedicated for the requests. When a new environment is set up for an invoked request, the new environment can be subject to different levels of access control and security standard. In some implementations, the parent server or system can be the one to define those access control and security measurements to provide a secure way to authenticate a user of a parent system in a spawned service, for example, without requiring additional or different authentication methods for the same user.

In some implementations, when a service (or server environment) spawned by a parent system requires authentication to provide services (e.g., access to virtual resources), the spawned service provides authentication methods for identifying users requesting these services. In some implementations, transferring credentials across service can be associated with risks of security breaches; however, requirements for multiple authentications at multiple services may be cumbersome and time-consuming tasks associated with multiple points of potential security breaches. Additionally, requiring multiple separate authentication steps can be inconvenient for users. Using tokens provides a mechanism to avoid transferring credentials across systems or services.

A token issued for a user at a first environment may not be valid in a trust domain of a remote environment (e.g., a remote service). In those implementations, such a token cannot be directly used at the remote environment for authentication because the remote environment would not validate such token. In some implementations, a mechanism to exchange a token for a user that is valid at a first environment for a token that is valid in a remote trust domain at the remote environment can promote secure yet faster authentication between different environments that improves the user's experience. For example, the mechanism can support single authentication for the user that is performed with fewer interactions with the environments to authenticate. In some implementations, the remote environment only trusts tokens issued by its own identity provider (which can be different from the identity provider of the first environment).

In some embodiments, the system establishes a one-way trust between the identity layer where the user is already logged-in (at the first environment), and an identity layer of a spawned environment (e.g., remote environment or service) on behalf of the user. The system can establish the one-way trust as part of a process of bootstrapping the remote environment to serve a request received from a user at the first environment. The process of authentication of a user in a trust domain of a remote environment may require a multi-token exchange between the first environment and a remote identity provider layer at the remote environment in order to acquire an identity token that is valid at the remote environment.

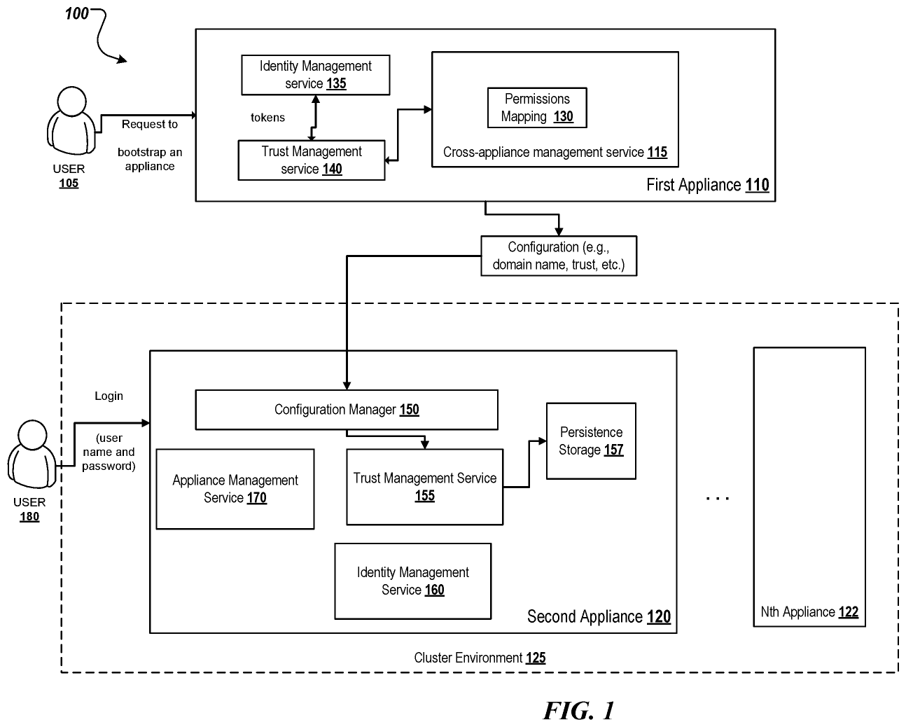

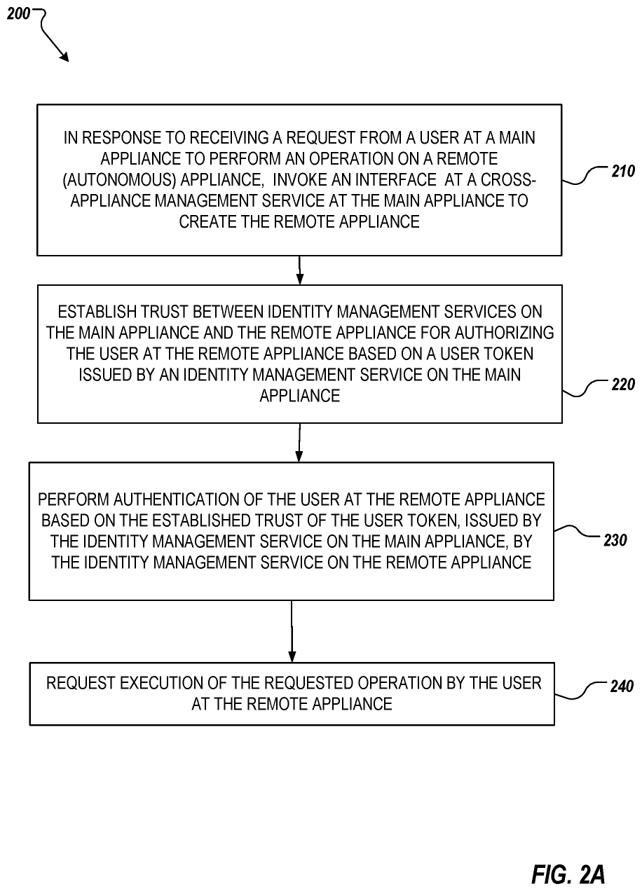

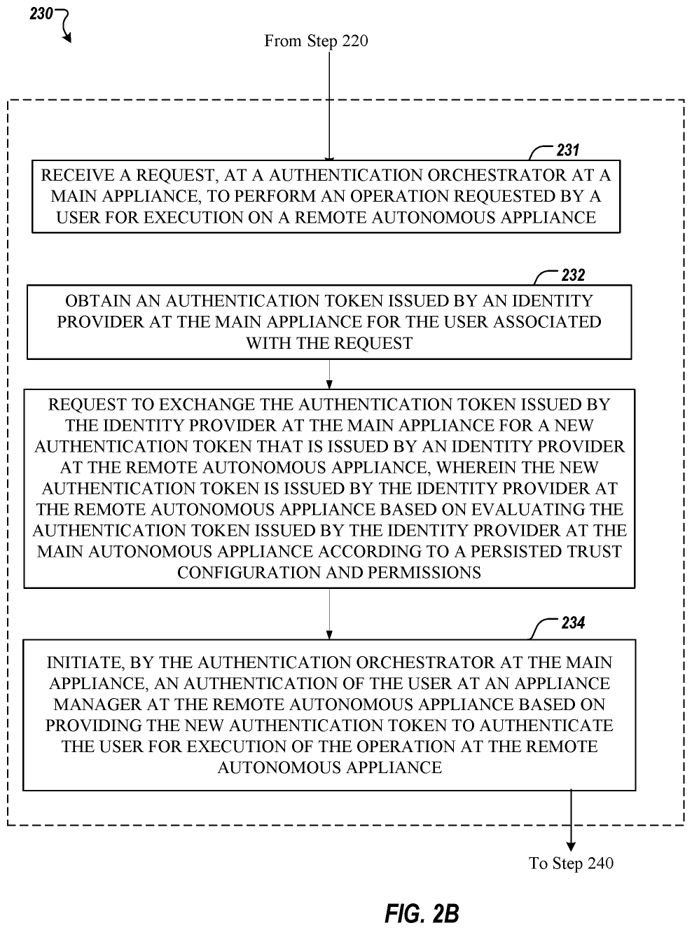

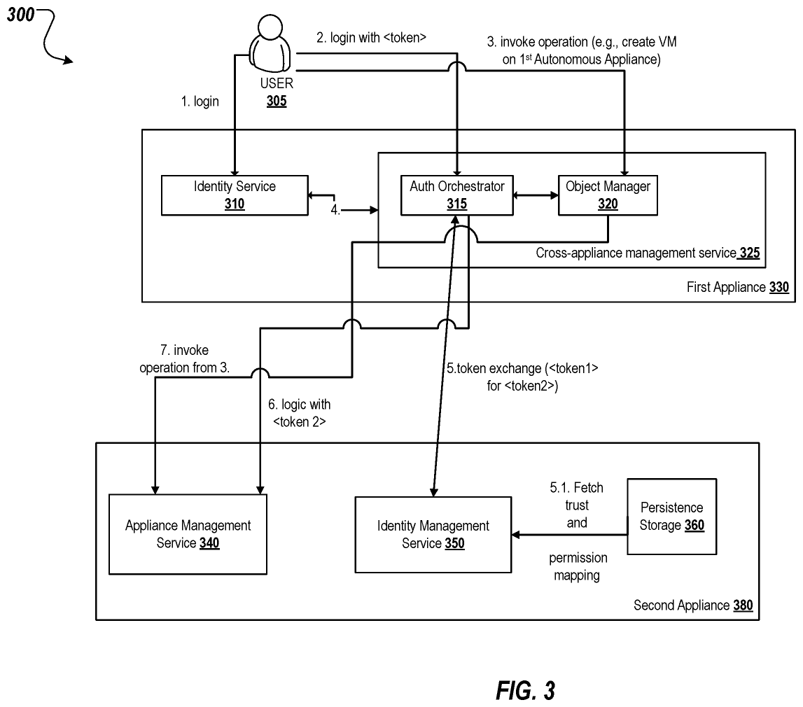

In some implementations, the system establishes a trust between two environments, e.g., a main, first appliance and a second, remote appliance, as described in relation to FIGS. 1 and 2A, where token exchange mechanisms relying on established trust between the remote environments can be implemented as described in relation to FIGS. 2B and 3.

In accordance with the present implementations, an automatic way of orchestrating a multi-token exchange on behalf of a user logged in a first appliance and invoking services in a remote trust domain at a second appliance can be performed based only (or substantially) on a one-way trust established between a domain the user belongs to (at the first appliance) and the remote one (at the second appliance).

In some implementations, based on an established trust between an identity provider at a remote appliance and a main appliance, an automatic orchestration of exchange of tokens to authenticate a user at a remote appliance is supported. Such automatic orchestration promotes no obligation for either system to maintain prior knowledge about remote users and support secure and fast authentication process for users who are once authenticated at a main appliance. Thus, transitioning service execution from a point where the service is requested, for example, a main appliance, to an execution point, for example, a remote appliance that runs on separate hardware independently from the first main appliance, can be smoothly executed without interruptions for the user. Further, separation of execution of operations related to received requests for use of virtual resources provided by a remote appliance which were requested at a main appliance promotes high availability of the provided services, where service level can be maintained even if a downtime or another interruption (e.g., a restart of a server, an update or upgrade of an environment, among other examples) at the main appliance is experienced.

FIG. 1 is a schematic diagram illustrating an example computing environment 100 in which a system establishes trust between identity providers at a first appliance 110 and a second appliance 120.

The computing environment 100 includes a first appliance 110 and a cluster environment 125 where one or more appliances can be instantiated based on requests received from the first appliance 110. The first appliance 110 can be a main appliance that provide server management implemented logic including logic for managing services and/or sub-services for managing clusters or appliances at the cluster environment 125. In some implementations, the first appliance 110 includes a cross-appliance managing service 115 that can be considered as a parent service to one or multiple appliance management services running on appliances instantiated at the cluster environment 125.

The first appliance 110 further includes a trust management service 140 and an identity management service 135 that are configured support token based authentication of users sending requests to the first appliance 110.

A user 105 can submit a request to bootstrap an appliance from the first appliance 110. For example, the user 105 can submit the request from a dedicated user interface provided by the first appliance 110. In some cases, before the user requests to bootstrap an appliance, the user 105 needs to be authenticated by the identity management service 135. The authentication can be performed by a token-based log-in operation, where the identity management service 135 can issue a token for the user 105 in response to validating the user's credentials. In some instances, the issued token is used at the first appliance 110 when the user 105 requests execution of operations (e.g., invokes application programming interfaces (APIs) exposed to receive external calls). For example, requested operations can include requests for virtual resource management services such as requesting to create a VM, to manage a VM, to stop a VM, or to perform lifecycle management on a VM, among other example operations.

In some implementations, the user 105 requests execution of an operation related to a new appliance, e.g., second appliance 125, at the cross-appliance managing service 115. The cross-appliance managing service 115 supports system domains where different users are associated with different and/or multiple system domains. The cross-appliance managing service 115 instantiates the second appliance 125 and configures the second appliance 125 to establish one-way trust between (looks like you are missing the end of this sentence)

In some implementations, the first application 110 and the identity management service 135 support multiple authentication methods, including token based authentication, credential-based authentication, others. In some of those implementations, an instantiated appliance (or cluster), such as the second appliance 120, at the cluster environment 125 may support logins, for example, from a user 180 or user 105, that are based on tokens issued by identity management service at that cluster appliance or direct login (e.g., based on username and password). Such login request can be initiated from users of the first appliance 110 or from user associated with local domains defined for that cluster appliance.

In some implementations, security tokens issued by the first appliance are trusted within the first appliance 110, and therefore a token issued by the identity management service 135 cannot be directly used as an authentication secret for login in an appliance at the cluster environment 125, for example, for login at the second appliance 120. In order to enable such authentication at an appliance at the cluster environment 125, the first appliance 110 needs to establish trust between the identity management service 135 (identity provider) at the first appliance 110 and an identity provider at a respective appliance at the cluster environment.

The cluster environment 125 includes one or more appliances including the second appliance 120 and the N-th appliance 122. These appliances can be autonomous environments that provide services invoked by users through the first appliance 110. The appliances at the cluster environment 125 can be configured in a way where trust is established in the direction from the appliances at the cluster environment to the first appliance 110. The trust can be used to automatically exchange a token issued for a user at the first appliance 110 for a new, different token issued for that user at an appliance that trusts the first appliance. In some implementations, the automatic orchestration of the initiation and exchange of tokens, and/or authentication at an appliance at the cluster environment can be performed based on logic implemented at the cross-appliance management service 115. For example, such automatic orchestration can be performed as described in relation to FIG. 3.

In some implementations, during bootstrapping an appliance, such as the second appliance 120 at the cluster environment 125 based on a request for an operation by the user 105 at the first appliance 110, the system establishes trust between the cross-appliance managing service 115 and an appliance management service 170. The cross-appliance management service 115 calls the trust management service 140 of the first appliance to fetch certificates for signing token by the identity management service 135. Those fetched certificates are added to a configuration 145 that is generated by the first appliance 110 when the second appliance 120 is instantiated. The configuration 145 is generated to be used for configuring the deployed second appliance 120. The cross-appliance managing service 115 obtains other configuration data related to the infrastructure and domains associated with the first appliance 110 and adds the additional configuration data to the generated configuration 145. In some instances, the cross-appliance management service 115 includes permission mappings 130 that are defined for users and domains associated with the first appliance 110. The cross-appliance managing service 115 adds the permissions mappings to the configuration 145. In such manner, the configuration 145 can be persisted at the second appliance 120 and the permission mappings 130 can be used to determine whether to provide a user who is authenticated at the first appliance with a new token issued in exchange at the second appliance. The system can evaluate the user token based on evaluating a user group that the user belongs to and a defined mapping for a corresponding user group, role, or else at the second appliance 120 when generating the new token at the identity management service 160 at the second appliance 120. The first appliance 110 includes information at configuration 145 about the system domains and domain names supported at the first appliance 110.

The cross-appliance managing service 115 pushes the configuration 145 to the configuration manager 150 of the second appliance 120. The configuration manager 150 can obtain the information including the certificates, server configurations, domain names, and other relevant data to apply the configuration at the second appliance 120 and persist the trust (including the certificates from the permission mappings 130) at the persistence storage 157 of the second appliance 120.

For example, based on the established trust between the cross-appliance managing service 115 and the appliance managing service 170, users from the first appliance that are members of a particular group, such as administrator group, can successfully execute operations which effectively reach the second appliance 120.

FIG. 2A is a flowchart of an example process 200 for bootstrapping a second remote appliance from a first main appliance as an autonomous appliance that runs independently in accordance with some embodiments. In some implementations, the example process 200 can be executed by a system implementing the example computing environment 100 of FIG. 1 or at the example computing environment 300 of FIG. 3 presented below. In some implementations, the example process 200 is a process for authentication of a user at an autonomous appliance that is bootstrapped from a main appliance in response to a request for an execution of an operation received at the main appliance. A user can authenticate with the main appliance to perform the request for the operation. For example, the authentication can be token-based. In some instances, the execution of the operation at another appliance that is a standalone appliance is associated with separate authentication that cannot authenticate the user based on the credential or authentication token used by the user at the main appliance.

In some implementations, a user requests an operation, e.g., start a virtual machine (VM) at a virtual environment provided by a main appliance. In some implementations, the main appliance implements logic to instantiate a virtual machine at another appliance, such as a second appliance that is remote and autonomous appliance separate from the first main appliance. In some cases, the other appliance can run on infrastructure associated (or dedicated) for a user or a user group that the user belongs to.

At 210, in response to receiving a request for bootstrapping an appliance to start a VM from the user, the system invokes an interface at the main appliance. The interface is invoked to create (or manage) a virtual resource (e.g., create a VM) at a remote appliance different from the main appliance. When the remote appliance is create, trust between the identity providers of the main appliance and the remote appliance is established.

In some implementations, to establish the trust, the remote appliance is configured according to a generated configuration specification at the main appliance. The establishment of trust can include that the main appliance generate the configuration specification that includes authentication certificates associated with the user that are relevant for the remote appliance. The main appliance determine the authentication certificates that are to be included in the configuration specification based on evaluating claim mapping rules that define authentication privileges for the user with respect to one or more domains. In some instances, a trust managing service at the main appliance provides the authentication certificates for the configuration generation. The trust managing service can obtain those certificates from the identity provider at the main appliance.

Based on the provided configuration specification by the main appliance, the remote appliance can be configured to establish the trust between the identity providers at the main and the remote appliance. The established trust is one-way trust where a user that is authenticated at the main appliance can be trusted at the remote appliance, since the certificates from the main appliance are trusted by the identity provider of the remote appliance. The established trust does not apply in the other direction, and a user who is authenticated at the remote appliance may not have valid authentication at the main appliance based on solely his authentication confirmation at the remote appliance.

In some implementations, the remote appliance is a secure environment requiring authentication, where different mechanisms for authentication can be supported. In some cases, users authenticated at a trusted appliance can be authenticated at the remote appliance, such as a user who has valid access rights to the main appliance as discussed above. In addition, the remote appliance may support direct authentication based on user credentials such as a user name and a password that can be provided directly to the remote appliance.

At 220, the system establishes trust between the identity provider at the remote appliance and the identity provided at the main appliance. The trust allows a user token issued by the identity provider at the main appliance to be trusted by the remote appliance when provided by the main appliance. The remote appliance can then issue a corresponding user token by the identity provider at the remote appliance. The corresponding user token can be returned to the main appliance and can allow the main appliance to automatically send requests from the main appliance for the remote autonomous appliance without requiring additional authentication steps.

In some implementations, the user is associated with a domain defined at the main appliance and is a member of a group that is authorized to execute one or more operations related to virtual resources at the remote appliance. The new authentication token issued for the remote appliance defines privileges at the remote appliance that correspond to privileges determined based on evaluation of permission mappings defined at the main appliance according to the group of the user.

In some implementations, once one-way trust is established between the identity provider at the remote appliance and the identity provider at the main appliance, an orchestrator at the main appliance requests a user token issued by the identity provider at the main appliance to be exchanged for a new token that is to be trusted by an identity layer, for example, an identity service or provider, at the remote appliance. The new token is issued by the identity layer at the remote appliance based on validating the provided user token issued by the identity provider at the main appliance and the persisted trust configuration at the remote appliances. Based on an established one-way trust between the identity layer of the remote appliance to the identity provider of the main appliance, a new token for the user that is valid at the remote appliance can be automatically issued and provided to the main appliance. Once such a token is provided to the main appliance, the new token is used to perform a log-in operation initiated from the main appliance to the remote appliance based on this new token. In response to successful authentication based on the new token, the request as received from the user at the main appliance to perform an operation at the remote appliance can be requested as an authenticated request. The execution of the operation at the main appliance can be based on validating authorization rights of the user.

At 230, the main appliance of the system requests authentication to be performed for the user at the remote appliance based on the established trust of the user token issued by the identity provider at the main appliance. The identity provider at the remote appliance can verify the user token issued by the identity provider at the main appliance and determine whether such user token can be trusted, and issue a new authentication token. The performed authentication is based on an exchange of tokens performed by the identity provider at the remote application that receives the user token and provides a new token in response to determining that the first user token can be trusted.

At 240, the system requests execution of the user requested operation at the remote appliance, since the user is authenticated to interact with the remote appliance with regard to performing requested operations for which the user is authorized based on their access privileges.

FIG. 2B is a flowchart of an example process 230 for authenticating a user at a second appliance based on user's authentication at a remote appliance in accordance with some embodiments. In some implementations, the example process 230 can be executed by a system implementing the computing environment 100 of FIG. 1 or at the example computing environment 300 of FIG. 3 presented below. In some implementations, the example process 230 is a process for performing authentication of a user at an autonomous appliance that is bootstrapped from a main appliance. In such manner, a user who is authorized based a user token at the main appliance can request operations at the autonomous appliance by relying an underlying automatic exchange of authentication tokens between the identity layers at the main and remote appliances.

At 231, an authentication orchestrator at a main appliance receives a request to perform an operation requested by a user for execution on a remote appliance.

In some implementations, the main appliance receives the request from an object manager for the first appliance. In some implementations, the object manager runs on the main appliance together with the authentication orchestrator as part of a cross-appliance managing service that manages requests associated with virtual resources provided by the first appliance.

In some implementations, there can be one or more object managers at the main appliance that are associated to one or more different remote appliances that are bootstrapped from the main appliance.

In some implementations, the remote appliance is an autonomous appliance that runs on different hardware compared to the hardware for the main appliance. The two appliances can be communicatively coupled where the remote appliance is instantiated to support work balance for requests received at the main appliance. In some implementations, the remote appliance is executed as part of a cluster of autonomous appliances. In an example context of a client environment, a platform or service provider can host the main appliance, where the remote appliance and/or other autonomous appliances bootstrapped based on received requests at the main appliance can run in environments maintained and hosted by different customers of the platform or service provider. Thus, different appliances can support isolation of data and maintain high availability of services that run at separate distinct infrastructures that can support independent execution of requests (e.g., for example managing requests for virtual resources consumed at the autonomous appliances).

At 232, the authentication orchestrator at the main appliance obtains an authentication token issued by an identity provider at the main appliance for the user associated with the request.

At 233, the authentication orchestrator requests to exchange the authentication token issued by the identity provider at the main appliance for a new authentication token that is issued by an identity provider at the remote appliance. The new authentication token is issued by the identity provider at the remote appliance based on evaluating the authentication token issued by the identity provider at the remote appliance according to a persisted trust configuration and permissions.

In some implementations, the new authentication token is issued as a local token by the identity provider at the remote appliance. The identity provider at the remote appliance generates the new authentication token in response to verifying that the provided authenticated token issued by the identity provider of the main appliance is signed by the identity provider of the main appliance as a trusted signer. Such verification can be performed based on a pre-established trust between the identity provider of the remote appliance for tokens issued by the main application. In some implementations, the identity provider at the remote appliance issues the new authentication token in response to an evaluation of the authentication token issued by the identity provider of the main appliance. The authentication token issued by the identity provider of the main appliance can be evaluated according to persisted trust data configured at the remote appliance for tokens issued by the main appliance based on predefined claim mappings defined for a user group associated with the user at the main appliance.

At 234, the authentication orchestrator at the main appliance initiates an authentication of the user at an appliance manager at the remote appliance based on providing the new authentication token to authenticate the user for execution of the operation at the remote autonomous appliance.

In some implementations, the authentication orchestrator receives the request to perform the operation an object manager that is dedicated to the remote appliance and that runs on the main appliance. In some cases, in response to a successful log-in at the appliance manager based on the new authentication token, the object manager automatically transfers the request for the operation as received to the remote appliance. The request can be authenticated for execution based on a successful authentication of the user as initiated by the authentication orchestrator at the main appliance.

FIG. 3 is a schematic diagram illustrating an example computing environment 300 where a second appliance, based on a request received at a remote appliance, is bootstrapped as an autonomous appliance that includes an identity layer that trusts the identity layer of the remote appliance n in accordance with some embodiments.

In some implementations, the computing environment 300 is substantially similar to the computing environment 100 of FIG. 1. The computing environment 300 is an environment where trust has been established between a first appliance 330 and a second appliance 380, where the first appliance 330 can correspond to the first appliance 110 of FIG. 1, and the second appliance 380 may correspond to the second appliance 125 of FIG. 1.

In some implementations, the computing environment 300 is configured as described in relation to FIG. 1 and FIG. 2B, and the second appliance is instantiated as an autonomous appliance that can execute operations invoked through the first appliance 330. The second appliance 380 requires authentication to perform operations. In some instances, the second appliance 380 can be limited to support token-based authentication and direct credential based authentication for users that are related to the first appliance 330.

In some implementations, the example process 200 of FIG. 2A can be implemented for execution at the computing environment 300 to support automatic orchestration of token authentication of a user authenticated at the first appliance 300.

As illustrated in FIG. 3, at 1, a user 305, e.g., who is a member of a group defined for a given domain associated with the first appliance 330, logs in to an identity service 310 with authentication information e.g., a username and password. The user 305 obtains a token based on verification of the provided authentication information. The user 305 provides, at 2, a login request with the obtained token to an authentication orchestrator 315 to perform a token-based logic at the cross-appliance managing service 325 of the first appliance. The cross-appliance managing service 325 can be substantially similar to the cross-appliance managing service 115 of FIG. 1. The object manager 320 is communicatively coupled to the authentication orchestrator 315. The object manager 320 is configured to communicate with the authentication orchestrator 315 to invoke an operation, at 3, to initiate an authentication process for the user 305 at the second appliance 380.

At 3, the user 305 invokes a relevant interface (e.g., API) associated with a requested operation (e.g., to create a VM on the second appliance 380). In some instances, the request is received at an object manager 320. The object manager 320 can be a dedicated entity for serving requests related to the second appliance 380. In some instances, the first appliance 330 can include further object managers, similar to the object manager 320, that are related to execution of virtual resource management operations at respective other appliances (e.g., other appliances of a cluster environment as described in FIG. 1).

At 4, the cross-appliance managing service 325 communicates with the identity service 310 to obtain a relevant token for the user 305 that is relevant for the cross-appliance managing service 325 to perform a login operation on behalf of the user at the second appliance 380.

At 5, the authentication orchestrator 315 performs a request to the identity management service 350 of the second appliance to request an exchange of the token of the user 305 as used for login at 2, for a local token that is valid at the second appliance 380. The identity management service 350 is configured to evaluate the received token of the user 305 and based on determining that there is established trust between the identity management service 350 and the issuer of the token, i.e., the identity service 310. The identity management service 350 can determine whether the token is to be trusted based on fetching configured trust (as described in relation to FIG. 1) that is stored at a persistence storage 360. The persistence storage 360 can be substantially similar to the persistence storage 157 of FIG. 1. The persistence storage 360 stores trust data maintained for main appliances that can be trusted to issue a token that is valid for the second appliance 380 based on evaluating the signature of the token provided for user 305. Since the token is issued by the identity management service 350 and is signed with appropriate certificates of that identity provider, the identity management service can evaluate (at 5.1) whether the certificates correspond to the persisted trust and the permissions mapping maintained for the first appliance 330 at the persistence storage 360. The identity management service 350 can issue a new token in exchange for the received token at 5.

At 6, the authentication orchestrator 315 requests to log in to the appliance management service 340 of the second appliance 380 based on the received new token from the identity management service 350. The appliance management service 340 can be substantially similar to the appliance management service 170 of FIG. 1. The login can be successfully performed since the provided token is a token that is issued by the local identity provider, i.e., the identity management service 350.

At 7, the object manager 320 invokes the operation that was requested by the user at 3, to be performed at the appliance management service 340. The operation can be requested at 7, because the user associated with the request is authenticated at the second appliance 380 which requires authentication to execute operations.

In accordance with implementations of the present disclosure, token exchange and authentication workflow can be integrated in a cross-appliance management service, such as the cross-appliance management service 325 to support users to seamlessly invoke operations at remote environments in a secure yet efficient manner. For example, the user 305 does not need to have knowledge how to perform authentication at a remote location and how to acquire a remote token and use it to invoke remote services. The described workflow at FIG. 3 supports generation of valid user token and establishing of user sessions at remote services in a fast manner with reduced resources and fewer interaction steps.

Embodiments of the subject matter described in this specification include computer systems, apparatus, and computer programs recorded on one or more computer storage devices, each configured to perform the actions of the described methods. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory program carrier for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. The computer storage medium can be a machine-readable storage device, a machine-readable storage substrate, a random or serial access memory device, or a combination of one or more of them.

The term “data processing apparatus” refers to data processing hardware and encompasses all kinds of apparatus, devices, and machines for processing data, including by way of example a programmable processor, a computer, or multiple processors or computers. The apparatus can also be or further include special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, a module, a software module, a script, or code, can be written in any form of programming language, including compiled or interpreted languages, or declarative or procedural languages, and it can be deployed in any form, including as a standalone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a communication network.

For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Computers suitable for the execution of a computer program include, by way of example, can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and pointing device, e.g., a mouse, trackball, or a presence sensitive display or other surface by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone, running a messaging application, and receiving responsive messages from the user in return.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communications network. Examples of communications networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

In addition to the embodiments described above, the following embodiments are also innovative:

Example 1 is 1 a computer-implemented method comprising:
receiving a request, at an authentication orchestrator at a main appliance, to perform an operation requested by a user for execution on a remote appliance;
obtaining an authentication token issued by an identity provider at the main appliance for the user associated with the request;
sending a request to the remote appliance requesting an exchange of the authentication token issued by the identity provider at the main appliance for a new authentication token that is issued by an identity provider at the remote appliance, wherein the new authentication token is issued by the identity provider at the remote appliance based on evaluating the authentication token issued by the identity provider at the main appliance according to a persisted trust configuration and permissions; and
initiating, by the authentication orchestrator at the main appliance, an authentication of the user at an appliance manager at the remote appliance based on providing the new authentication token to authenticate the user for execution of the operation at the remote appliance.

Example 2 is the method of Example 1, wherein receiving the request to perform the operation is received from an object manager for the remote appliance, wherein the object manager runs on the main appliance together with the authentication orchestrator as part of a cross-appliance managing service that manages requests associated with virtual resources provided by the remote appliance.

Example 3 is the method of any one of the previous examples, wherein the main appliance and the remote appliance are running on different hardware at communicatively coupled locations.

Example 4 is the method of any one of the previous examples, wherein the request is received from an object manager that is dedicated to the remote appliance and that runs on the main appliance, wherein the method comprises:

in response to a successful log-in at the appliance manager based on the new authentication token, automatically transferring the request for the operation as received by the object manager to the remote appliance, wherein the request is authenticated for execution based on a successful authentication of the user as initiated by the authentication orchestrator at the main appliance.

Example 5 is the method of any one of the previous examples, wherein the new authentication token is issued as a local token by the identity provider at the remote appliance, wherein the new authentication token is generated in response to verifying that the provided authenticated token issues by the identity provider of the main appliance is signed by the identity provider of the main appliance as a trusted signer.

Example 6 is the method of any one of the previous examples, wherein the new authentication token is issued in response to an evaluation of the authentication token issued by the identity provider of the main appliance according to persisted trust data configured at the remote appliance for tokens issued by the main appliance based on predefined claim mappings defined for a user group associated with the user at the main appliance.

Example 7 is the method of any one of the previous examples, comprising:
establishing trust between the identity provider at the remote appliance and the identity provided at the main appliance so that a user token issued by the identity provider at the main appliance can be trusted to issue a corresponding user token by the identity provider at the remote appliance to automatically authenticate requests for the remote appliance received at the main appliance.

Example 8 is the method of example 7, wherein establishing the trust between the identity provider comprises:
in response to receiving a request from a user, invoking an interface at the main appliance to create a virtual resource at the appliance and to establish trust between the identity providers of the main appliance and the remote appliance;
generating a configuration specification for configuring the remote appliance, wherein the configuration specification includes authentication certificates associated with the user relevant for the remote appliance based on evaluating claim mapping rules defining authentication privileges for the user with respect to one or more domains associated with the user, the authentication certificates being provided by a trust managing service at the main appliance and obtained from the identity provider at the main appliance; and
configuring the remote appliance based on the configuration specification to establish the trust between the identity providers.

Example 9 is the method of any one of the previous examples, wherein the user is associated with a domain defined at the main appliance and is a member of a group that is authorized to execute one or more operations related to virtual resources at the remote appliance, and wherein the new authentication token issued for the remote appliance defines privileges at the remote appliance that correspond to privileges determined based on evaluation of permission mappings defined at the main appliance according to the group of the user.

While this specification contains many specific implementation details, these should not be construed as limitations on the scope of any implementation or on the scope of what may be claimed, but rather as descriptions of features that may be specific to particular implementations of the disclosure. Certain features that are described in this specification in the context of separate implementations can also be implemented in combination or in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In certain implementations, multitasking and parallel processing can be advantageous.

What is claimed is:

1. A computer-implemented method comprising:
receiving a request, at an authentication orchestrator at a main appliance, to perform an operation requested by a user for execution on a remote appliance;
obtaining an authentication token issued by an identity provider at the main appliance for the user associated with the request;
sending a request to the remote appliance requesting an exchange of the authentication token issued by the identity provider at the main appliance for a new authentication token that is issued by an identity provider at the remote appliance, wherein the new authentication token is issued by the identity provider at the remote appliance based on evaluating the authentication token issued by the identity provider at the main appliance according to a persisted trust configuration and permissions; and
initiating, by the authentication orchestrator at the main appliance, an authentication of the user at an appliance manager at the remote appliance based on providing the new authentication token to authenticate the user for execution of the operation at the remote appliance.

2. The method of claim 1, wherein receiving the request to perform the operation is received from an object manager for the remote appliance, wherein the object manager runs on the main appliance together with the authentication orchestrator as part of a cross-appliance managing service that manages requests associated with virtual resources provided by the remote appliance.

3. The method of claim 1, wherein the main appliance and the remote appliance are running on different hardware at communicatively coupled locations.

4. The method of claim 1, wherein the request is received from an object manager that is dedicated to the remote appliance and that runs on the main appliance, wherein the method comprises:
in response to a successful log-in at the appliance manager based on the new authentication token, automatically transferring the request for the operation as received by the object manager to the remote appliance, wherein the request is authenticated for execution based on a successful authentication of the user as initiated by the authentication orchestrator at the main appliance.

5. The method of claim 1, wherein the new authentication token is issued as a local token by the identity provider at the remote appliance, wherein the new authentication token is generated in response to verifying that the provided authenticated token issues by the identity provider of the main appliance is signed by the identity provider of the main appliance as a trusted signer.

6. The method of claim 1, wherein the new authentication token is issued in response to an evaluation of the authentication token issued by the identity provider of the main appliance according to persisted trust data configured at the remote appliance for tokens issued by the main appliance based on predefined claim mappings defined for a user group associated with the user at the main appliance.

7. The method of claim 1, comprising:
establishing trust between the identity provider at the remote appliance and the identity provided at the main appliance so that a user token issued by the identity provider at the main appliance can be trusted to issue a corresponding user token by the identity provider at the remote appliance to automatically authenticate requests for the remote appliance received at the main appliance.

8. The method of claim 7, wherein establishing the trust between the identity provider comprises:
in response to receiving a request from a user, invoking an interface at the main appliance to create a virtual resource at the appliance and to establish trust between the identity providers of the main appliance and the remote appliance;
generating a configuration specification for configuring the remote appliance, wherein the configuration specification includes authentication certificates associated with the user relevant for the remote appliance based on evaluating claim mapping rules defining authentication privileges for the user with respect to one or more domains associated with the user, the authentication certificates being provided by a trust managing service at the main appliance and obtained from the identity provider at the main appliance; and
configuring the remote appliance based on the configuration specification to establish the trust between the identity providers.

9. The method of claim 1, wherein the user is associated with a domain defined at the main appliance and is a member of a group that is authorized to execute one or more operations related to virtual resources at the remote appliance, and wherein the new authentication token issued for the remote appliance defines privileges at the remote appliance that correspond to privileges determined based on evaluation of permission mappings defined at the main appliance according to the group of the user.

10. A non-transitory, computer-readable medium coupled to one or more processors and having instructions stored thereon which, when executed by the one or more processors, cause the one or more processors to perform operations, the operations comprising:
receiving a request, at an authentication orchestrator at a main appliance, to perform an operation requested by a user for execution on a remote appliance;
obtaining an authentication token issued by an identity provider at the main appliance for the user associated with the request;
sending a request to the remote appliance requesting an exchange of the authentication token issued by the identity provider at the main appliance for a new authentication token that is issued by an identity provider at the remote appliance, wherein the new authentication token is issued by the identity provider at the remote appliance based on evaluating the authentication token issued by the identity provider at the main appliance according to a persisted trust configuration and permissions; and
initiating, by the authentication orchestrator at the main appliance, an authentication of the user at an appliance manager at the remote appliance based on providing the new authentication token to authenticate the user for execution of the operation at the remote appliance.

11. The computer-readable medium of claim 10, wherein receiving the request to perform the operation is received from an object manager for the remote appliance, wherein the object manager runs on the main appliance together with the authentication orchestrator as part of a cross-appliance managing service that manages requests associated with virtual resources provided by the remote appliance.

12. The computer-readable medium of claim 10, wherein the request is received from an object manager that is dedicated to the remote appliance and that runs on the main appliance, wherein the method comprises:
in response to a successful log-in at the appliance manager based on the new authentication token, automatically transferring the request for the operation as received by the object manager to the remote appliance, wherein the request is authenticated for execution based on a successful authentication of the user as initiated by the authentication orchestrator at the main appliance.

13. The computer-readable medium of claim 10, wherein the new authentication token is issued as a local token by the identity provider at the remote appliance, wherein the new authentication token is generated in response to verifying that the provided authenticated token issues by the identity provider of the main appliance is signed by the identity provider of the main appliance as a trusted signer, wherein the new authentication token is issued in response to an evaluation of the authentication token issued by the identity provider of the main appliance according to persisted trust data configured at the remote appliance for tokens issued by the main appliance based on predefined claim mappings defined for a user group associated with the user at the main appliance.

14. The computer-readable medium of claim 10, comprising instructions stored thereon which, when executed by the one or more processors, cause the one or more processors to perform operations comprising:
establishing trust between the identity provider at the remote appliance and the identity provided at the main appliance so that a user token issued by the identity provider at the main appliance can be trusted to issue a corresponding user token by the identity provider at the remote appliance to automatically authenticate requests for the remote appliance received at the main appliance, wherein establishing the trust between the identity provider comprises:
in response to receiving a request from a user, invoking an interface at the main appliance to create a virtual resource at the appliance and to establish trust between the identity providers of the main appliance and the remote appliance;
generating a configuration specification for configuring the remote appliance, wherein the configuration specification includes authentication certificates associated with the user relevant for the remote appliance based on evaluating claim mapping rules defining authentication privileges for the user with respect to one or more domains associated with the user, the authentication certificates being provided by a trust managing service at the main appliance and obtained from the identity provider at the main appliance; and
configuring the remote appliance based on the configuration specification to establish the trust between the identity providers.

15. A system comprising
a computing device; and
a computer-readable storage device coupled to the computing device and having instructions stored thereon which, when executed by the computing device, cause the computing device to perform operations, the operations comprising:
receiving a request, at an authentication orchestrator at a main appliance, to perform an operation requested by a user for execution on a remote appliance;
obtaining an authentication token issued by an identity provider at the main appliance for the user associated with the request;
sending a request to the remote appliance requesting an exchange of the authentication token issued by the identity provider at the main appliance for a new authentication token that is issued by an identity provider at the remote appliance, wherein the new authentication token is issued by the identity provider at the remote appliance based on evaluating the authentication token issued by the identity provider at the main appliance according to a persisted trust configuration and permissions; and
initiating, by the authentication orchestrator at the main appliance, an authentication of the user at an appliance manager at the remote appliance based on providing the new authentication token to authenticate the user for execution of the operation at the remote appliance.

16. The system of claim 15, wherein receiving the request to perform the operation is received from an object manager for the remote appliance, wherein the object manager runs on the main appliance together with the authentication orchestrator as part of a cross-appliance managing service that manages requests associated with virtual resources provided by the remote appliance.

17. The system of claim 10, wherein the request is received from an object manager that is dedicated to the remote appliance and that runs on the main appliance, wherein the method comprises:
in response to a successful log-in at the appliance manager based on the new authentication token, automatically transferring the request for the operation as received by the object manager to the remote appliance, wherein the request is authenticated for execution based on a successful authentication of the user as initiated by the authentication orchestrator at the main appliance.

18. The system of claim 15, wherein the new authentication token is issued as a local token by the identity provider at the remote appliance, wherein the new authentication token is generated in response to verifying that the provided authenticated token issues by the identity provider of the main appliance is signed by the identity provider of the main appliance as a trusted signer, wherein the new authentication token is issued in response to an evaluation of the authentication token issued by the identity provider of the main appliance according to persisted trust data configured at the remote appliance for tokens issued by the main appliance based on predefined claim mappings defined for a user group associated with the user at the main appliance.

19. The system of claim 15, wherein the computer-readable storage device comprises instructions stored thereon which, when executed by the one or more processors, cause the one or more processors to perform operations comprising:
establishing trust between the identity provider at the remote appliance and the identity provided at the main appliance so that a user token issued by the identity provider at the main appliance can be trusted to issue a corresponding user token by the identity provider at the remote appliance to automatically authenticate requests for the remote appliance received at the main appliance.

20. The system of claim 19, wherein establishing the trust between the identity provider comprises:
in response to receiving a request from a user, invoking an interface at the main appliance to create a virtual resource at the appliance and to establish trust between the identity providers of the main appliance and the remote appliance;
generating a configuration specification for configuring the remote appliance, wherein the configuration specification includes authentication certificates associated with the user relevant for the remote appliance based on evaluating claim mapping rules defining authentication privileges for the user with respect to one or more domains associated with the user, the authentication certificates being provided by a trust managing service at the main appliance and obtained from the identity provider at the main appliance; and
configuring the remote appliance based on the configuration specification to establish the trust between the identity providers.
